(19) United States
(12) Patent Application Publication
(10) Pub. No.: US 2015/0254944 A1
(43) Pub. Date: Sep. 10, 2015

(54) METHOD AND ARRANGEMENT FOR GENERATING AN AUDITORY ALERT SIGNAL

(71) Applicant: Interactive Institute Swedish ICT AB, Kista (SE)

(72) Inventors: Katarina DELSING, Pitea (SE); Anna SIRKKA, Pitea (SE); Mats LILJEDAHL, Arvika (SE); Stefan LINDBERG, Skelleftea (SE); Johan FAGERLÖNN, Pitea (SE)

(21) Appl. No.: 14/718,162

(22) Filed: May 21, 2015

Related U.S. Application Data
(63) Continuation of application No. PCT/SE2013/051306, filed on Nov. 6, 2013.

(30) Foreign Application Priority Data
Nov. 22, 2012 (SE) 1200715-9

(51) Int. Cl. G08B 3/10; H04R 3/02

(52) U.S. Cl. CPC G08B 3/10; H04R 3/02

(57) ABSTRACT

The present invention relates generally to an arrangement for generating an auditory alert signal (AAS) representing the state and/or location of an event (E1-Eₙ) and a method of creating such an auditory alert signal (AAS). The invention further relates to a computer program product executing the steps of the method and an auditory alert signal representing the state and/or location of an event.

### TECHNICAL FIELD

The present invention relates generally to an arrangement for generating an auditory alert signal representing the state of an event and a method of creating such an auditory alert signal. The invention further relates to a computer program product executing the steps of the method and an auditory alert signal representing the state of an event.

### BACKGROUND ART

Auditory signals and other type of signals are used in several environments to inform, warn or alarm of occurring situations. Examples of such environments are for example control rooms in industrial facilities, surveillance and communication rooms of all types, emergency rooms in hospitals or in the driving compartments of vehicles such as cars, commercial vehicles, airplanes and ships. In these environments multiple systems of different types and from different suppliers are often used.

The systems are using different types of signals to draw the operator's attention to that an event deviating from normal has occurred and in some cases also to inform the operator of the character of the specific event. If several events occur at the same time, the operator in the control room will be drowned with different signals such as sound, flashing lights or information appearing on a monitor. All these signals are difficult and time consuming to sort and might therefore take time to attend to. Further, the work environment for the operator can be stressful and confusing and all different systems can be difficult to learn.

In prior art, for example in U.S. Pat. No. 6,492,901 B1, it is disclosed an alarm management system using auditory signals to warn an operator of an upcoming alarming condition in a nuclear facility. Here the system receives all alarm signals and converts them in a data acquisition system into an alarm status signal. A sound generator generates a sound based on the alarm status signal. The sound is divided into an annunciation tone and a human voice signal. The tone alerts the operator of the status of the alarm, for example new alarm or return-to-normal alarm, and the voice signal give information about the alarm and direct attention to the operator in charge of the alarm. Both the tone and the human voice signal are chosen to have different frequencies to differentiate between different alarm statuses and which operator is responsible for the alarm.

A problem with the above system is that when using a human voice the system is language specific and might be misinterpreted. Further, when using the above system the priorities of the different alarm signals are not possible to transfer to the speakers. Instead the different alarm priorities are visualized on a computer screen in an alarm status overview.

Another system which with an acoustic signal alerts an operator of a malfunction of a plant is described in US2012/0206216A1. This is a system which acoustically represents the states of an industrial plant. Based on the states of the different machines in the plant, the system generates a continuous acoustic signal which may be a plurality of tracks, tones, noise or even a piece of music. When a change of state of the plant is detected the acoustic signal is changed so that the operator receives a clear acoustic status signal concerning the change of state. The acoustic signal may be manipulated for example by a dynamically change of pitch, response time or loudness.

This system is not depending on a human voice for reporting a malfunction; instead the operator is informed about the change of state via a change of tone or pitch of a continuous acoustic signal. Thus, the operator is detecting the state by examining if the plant sounds right. However, if a continuous signal is used it is difficult to monitor separate parts or machines of the plant. Especially if the system analyses over 1000 possible fault signals and transform them into one acoustic signal. Thus, it is difficult to directly know where the change of state occurs. It is also difficult to know in which order the faults have to be addressed, i.e. the priority of the detected malfunctions.

The present invention solves all the above mentioned problems and creates opportunities for an overall solution of parallel handling of multiple auditory signals in a complex environment. It also creates an opportunity to shorten the time it takes to transfer information about the event to the operator or user.

### SUMMARY OF INVENTION

An object of the present invention is to present a method and a system for generating an auditory alert signal representing the state and/or the location of an event. The method and system may be used to inform, warn or alarm of occurring situations or events deviating from normal in an industrial process, a human treatment process, a surveillance process, a vehicle operating process or other processes.

The method of generating an auditory alert signal representing the state and/or the location of an event comprises the steps of receiving an input signal indicative of the event, determining a priority, location and type of the event based on information received from the input signal, generating a priority signal forming a first part of the auditory alert signal, indicating the priority of the event, generating an association signal forming a second part of the auditory alert signal, indicating the location of the event and/or the type of event and transmitting the auditory alert signal comprising the priority signal and the association signal through at least one sound output.

The input signal may be a signal created manually or automatically when an event is deviating from the normal condition of an industrial process, a human treatment process, a surveillance process or a vehicle operating process. The input signal comprises information about the event such as its priority and the type and location of the event. When this signal is received by the system the input signal may be interpreted by a sound administrator arrangement and a priority signal and an association signal may be generated based on predetermined or adjustable rules of interpretation defined in the sound administrator arrangement. The priority sound may be used to indicate that an event deviating from normal has occurred, to communicate which priority the event has in relation to other possible events or in relation to consequences of the event and possibly also to give a first indication on which event that has occurred. The priority sound may further be specified by the following association sound. The association sound may be a sound which is used to give information on where the event is located, i.e. for example in which machine, which operation room or which engine part an event occur and/or the type of event. With the above described method it possible to transfer complex information of an occurring event to an operator of a process or user of a system in a quick an intuitive way.

In an embodiment of the invention, the step of transmitting the auditory alert signal comprising first transmitting the priority signal and then transmitting the association signal sequentially as different separate signals.

When the priority signal is first transmitted the operator or user is directly informed about the importance of the occurring event and his/her attention is fully awakened. The following association signal gives information on where and what event that need to be attended to.

In another embodiment of the invention, the method further comprises the steps of receiving the priority signal and the association signal from a sound library comprising standardized non-phonetic sounds and/or sub-sounds.

When using non-phonetic sounds and sub-sounds the auditory signal is independent of language and the method may be used and easily interpreted by operating personnel all over the world.

In another embodiment, the association signal may be based on a non-phonetic sound symbolizing the event. It may preferably be based on a sound recording or synthesized sounds or a combination of sound recordings and synthesized sounds. The association signal gives an immediate and intuitive indication of the type and/or location of the event without the usage of words.

When using a non-phonetic sound symbolizing the event as an association signal, the signal is easy to interpret and to understand. It is also normally pleasant to listen to. For example a water leak in a pipe may be represented by the sound of a falling water drop.

In another embodiment, also the priority signal may be a non-phonetic standard sound and/or an assembly of non-phonetic sub-sounds received from a sound library. Preferably, the priority signal is generated by assembling more than one non-phonetic sub-sound received from the sound library and/or generated by adjusting for example the volume, length, pitch or frequency distribution of the non-phonetic sounds or sub-sounds. Of course it is also possible to adjust other audio related parameters. It is also possible to generate a priority signal by assembling a different number of sub-sounds with a different distance between the sub-sounds.

In another embodiment, a priority signal indicating a higher priority comprises an excessive number of sub-sounds and/or extends over a longer period of time than a priority signal indicating a lower priority.

In another embodiment, the method further comprises the step of generating a priority family comprising an assembly of priority signals indicating different priorities. In a further embodiment, the priority family comprises a number of priority signals comprising a different number of sounds or sub-sounds having the same timbre but different pitch.

The above mentioned and described priority signals and generation of priority families and the relative relationship between the priority signals are based on the human intuitive knowledge of the surrounding sounds. For example, a sound emanating from a far distance has a more dull sound, i.e. a different frequency distribution, than a sound emanating from a place near. Further, a sound from a lion roaring far away has a lower priority than a lion roaring close by. This human knowledge is created by evaluation and is used in this inventive auditory alert system. When learning a system based on intuitive knowledge the learning process is easier and quicker.

In a further embodiment, the auditory alert signal may be transmitted through the at least one sound output over a time between 0.5 and 10 seconds, preferably 0.5 and 5 seconds, more preferably between 1 and 3 seconds.

When using a method based on non-phonetic signals it is possible to shorten the length of the signal transmitted, without losing any important information, into the above mentioned time intervals. A short but still informative signal, minimizes the time lag from when an event is detected and when the necessary measures have been taken to take care of the event.

In another embodiment, the method further comprises the steps of measuring the auditory character of the background noise, and adapting the auditory character of the auditory alert signal to the background noise making the signal more audible.

When the level and character of the background sound varies it can be difficult to hear the audio alert signal. When using the above described steps the character, for example the level and the frequency, of the background sound is measured with one or several sensors or microphones arranged at suitable locations in the surrounding environment in the control rooms, surveillance and communication rooms, emergency rooms or the driving compartments. The background noise is analyzed and the auditory alert signal adapted to the character of the background noise. I.e. either the volume, pitch or any other auditory parameter of the background noise is adjusted to the auditory parameters of the background noise. With this method it is for example possible to adjust the volume of the auditory alert signal to be lower at night and higher at day when more personnel are working in the room, thus making the signal more audible when there is more noise in the room.

In another embodiment, the method further comprises the steps of selecting a specific sound output based on the determined priority, location and type of event and transmitting the auditory alert signal through the selected specific sound output.

When using several sound outputs, preferably connected to several speakers, it is possible to transmit the auditory signal to the sound output closest to the operator in charge of the event. Which operator who is responsible depends on the determined priority, location and type of event.

The invention also relates to an arrangement for generating an auditory alert signal representing an event. The arrangement is characterized in that it comprises means for receiving an input signal indicative of the event, means for determining a priority, location and type of the event, means for generating a priority signal forming a first part of the auditory alert signal, indicating the priority of the event, means for generating an association signal forming a second part of the auditory alert signal, indicating the location and/or the type of event, and means for transmitting the auditory alert signal comprising the priority signal and the association signal through at least one sound output.

The above described arrangement is a tool for creating auditory alert signals in a complex working environment. The means for generating the priority and the association signal may preferably be controlled by a user interface where it is possible to control the parameters associated to the auditory alert signal. The system may come as preprogrammed software or may be possible to manually adapt by the operator.

In one embodiment the arrangement comprises a sound library comprising standardized non-phonetic sounds and/or sub-sounds from which the priority signal and the association signal is generated. Preferably, the association signal may be based on a sound recording or synthesized sounds or a combination of sound recordings and synthesized sounds and the priority signal comprising an assembly of more than one non-phonetic sub-sounds received from the sound library.

The invention also relates to a computer program product stored in a non-transitory computer readable medium which when executed on a computer performs the steps according to the above describes method.

The invention also relates to an auditory alert signal representing an event characterized in that it comprises a priority signal indicating the priority of the event and an association signal indicating the location and/or of the event. Preferably, the priority signal and association signal are non-phonetic and comprises different sound or sub-sounds.

### BRIEF DESCRIPTION OF DRAWINGS

The invention is now described, by way of example, with reference to the accompanying drawings, in which:

FIG. 1 disclose the principle of the auditory alert arrangement,

FIG. 2 disclose an example of the design of the auditory alert signal, and

FIG. 3 disclose an example of a control room in which the system can be used.

### DESCRIPTION OF EMBODIMENTS

The invention will now be described in more detail in respect of embodiments and in reference to the accompanying drawings. All examples herein should be seen as part of the general description and therefore possible to combine in any way in general terms. Again, individual features of the various embodiments may be combined or exchanged unless such combination or exchange is clearly contradictory to the overall method or function of the arrangement.

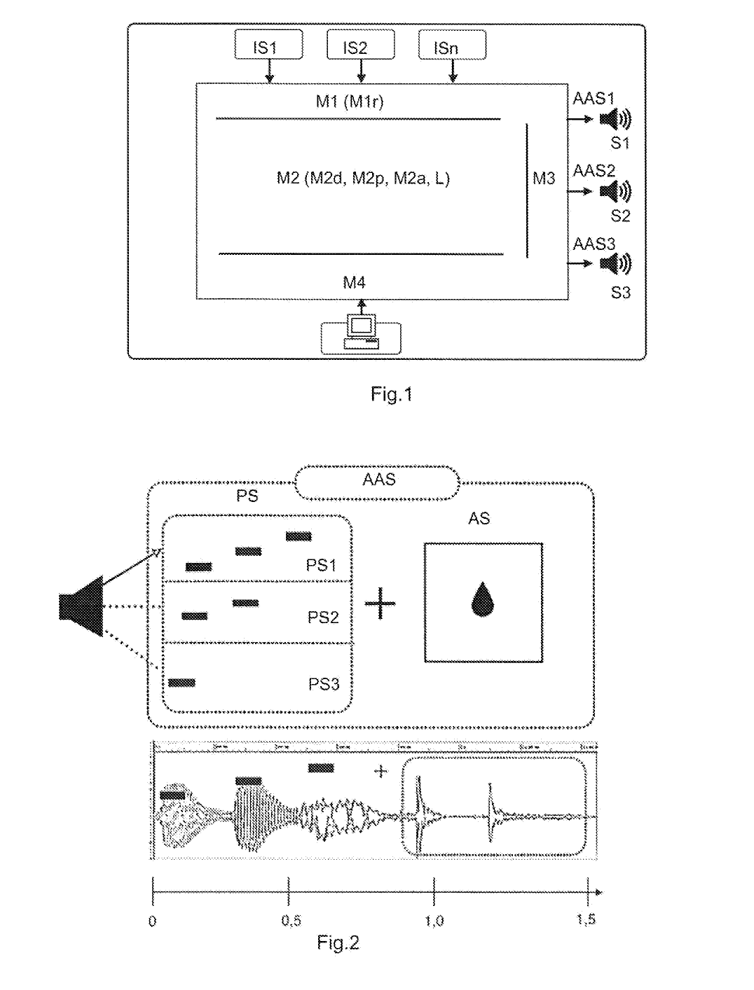

FIG. 1 discloses the principles of the auditory alert arrangement. The arrangement receives input signals IS1, IS2, . . . , ISn indicating an event occurring in an industrial process, a human treatment process, a surveillance process or a vehicle operating process, for example information/alarm signals emanated from sensors located at different locations in a process or a machine. The input signals IS1, IS2, . . . , ISn are related to signals created manually or automatically, for example when an event is deviating from the normal condition of the process, and comprises information about the event creating the alert, such as its priority and the type and location of the event. The input signals are handled with the means for handling the signal M1. The means for handing the input signals M1 also comprises means for receiving M1r.

Preferably, the arrangement comprises multiple entries which can handle several types of input signals IS1, IS2, . . . , ISn. This makes it possible to in a simple way integrate multiple systems of different types and from different suppliers in the auditory alert arrangement. Examples of input signals possible for the arrangement to handle are; relay contact released/closed, +24V of direct current off/on and network protocols via LAN over Ethernet. It is also possible to handle signals such as OPC-UA or other type of signals.

The input signal may be continuously analyzed and interpreted by an intelligent signal generating means M2. The signal generating means M2 also generates an auditory alert signal AAS which by using only different sounds delivers the necessary information about the event to the operator. The auditory alert signal AAS comprises a priority signal PS, forming a first part of the auditory alert signal, and an association signal AS, forming a second part of the auditory alert signal. See also FIG. 2. The signal generating means M2 comprises means for determining the priority, location and type of the event M2d and means for generating the priority and the association signals M2p, M2a.

Means for generating the priority and the association signals M2p, M2a receives the sounds and sub-sounds used to generate the priority and association signals PS, AS from a sound library L. The sound library L comprises several sound files with non-phonetic sounds and sub-sounds designed for the process specific events and may easily be updated with more sounds files if needed. The sounds and the sub-sounds in the library are of different types, for example sounds that mediate different degrees of priority, an association to a specific event or a specific feeling.

The auditory alert arrangement further comprises means M3 for transmitting the auditory alert signal AAS through at least one sound output S1-Sₙ, for example one or several speakers, in order to present the signal to the operator. The means for generating the priority and the association signal may preferably be controlled by a user interface M4, where it is possible to control the parameters associated to the auditory alert signal AAS.

The system may come as preprogrammed software or may be possible to manually adapt by the operator. The parameters controllable by the user interface M4 may for example be to which speakers S1-S3 the auditory alert signal AAS shall be transmitted, the volume of the auditory alert signal AAS or how many times the alert signal shall be repeated and with which interval.

FIG. 2 discloses the structure of the auditory alert signal AAS, where the signal comprises the first priority signal PS and the second association signal AS. The priority sound PS may be used to indicate that an event deviating from normal has occurred, to communicate which priority the event has in relation to other possible events or in relation to consequences of the event and possibly also to give a first indication on which event that has occurred. The priority sound PS is further specified by the following association sound AS. The association sound AS is a sound which may be used to give information on where the event is located, i.e. for example in which machine, which operation room or which engine part an event occur and the type of event.

The priority signal PS may be constructed by musical and acoustical parameters and is based on a non-phonetic standard sound and/or an assembly of non-phonetic sub-sounds received from the sound library L. The priority signal PS may be generated by assembling more than one non-phonetic sub-sound received from the sound library L. The time interval between the sub-sounds may also be adjusted. It is also possible to generate or adapt the priority signal by adjusting for example the volume, length or frequency distribution of the non-phonetic sounds or sub-sounds. Of course it is also possible to adjust other audio related parameters.

Priority signals PS of different levels of priorities, PS1, PS2, PS3, . . . , PSn may be assembled in a priority family. The different levels of priority may be assembled by musical and acoustical parameters, for example as temporal parameters such as number of tones/sub sounds, the distance between the tones/sub sounds or acceleration and retardation within the sequence. More tones played with a higher tempo or a longer or more distinct sequence of tones means a higher priority while a slower repeat rate and/or less tones communicates a lower priority. The priority family preferably comprises a number of priority signals comprising a different number of sounds or sub-sounds having the same timbre but different pitch.

In FIG. 2 it is disclosed an auditory alert signal AS comprising three different priority sounds PS with three priority levels PS1, PS2, PS3 comprising one, two or three tones respectively. The priority sound PS is followed by an association sound AS. The association sound AS is in this case the sound of a water drop falling into a fluid. The association sound AS is preferably based on sound recordings or synthesized sounds or a combination of sound recordings and synthesized sounds and shall be audible and pleasant to listen to.

The auditory alert signal may for example have the following characteristics associated with frequency and sound length;

Prio 1: Tone 1, 261 Hz [250 ms]-tone 2, 349 Hz [250 ms]-tone 3, 392 Hz [250 ms]—association signal[300 ms]
Prio 2: Tone 1, 261 Hz [250 ms]-tone 2, 349 Hz [250 ms]-association signal [300 ms]
Prio 3: Tone 1, 261 Hz [250 ms]-association signal[300 ms]
Between each separate tone/sub-sound there is a small time gap. Thus, the auditory alert signal in FIG. 2 is transmitted through the speakers S over a time between 0.5 and 1.5 seconds. It is also possible to repeat the priority or the association signal a desired number of times, which prolongs the duration of the auditory alert signal. This can be for example be adjusted in the user interface or software.

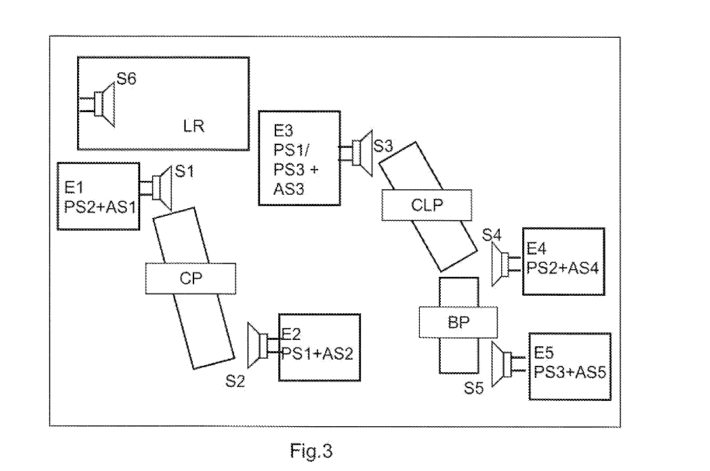

FIG. 3 discloses an example of control room in which the system can be used. The auditory alert signal is transmitted to several sound outputs, preferably connected to several speakers S1, S2, S3, S4, S5, S6. The speakers S1-S5 are located in vicinity of the operator in charge of a specific event and the speaker S6 is located in a room LR isolated from the control room, for example a lunch room. The speaker S6 is thus able to transmit all auditory alert signals and the operator in charge has to be observant and recognize his/her alert signal. Which operator who is responsible depends on the determined priority PS1-PSₙ, location and type of event E1-Eₙ.

If for example the system is used in an industrial facility such as a paper mill, as exemplified in FIG. 3, the events E1-E5 may be connected to a chip line process CLP, a bleaching process BP and a cleaning process CP. If an event E1-E5 deviating from normal occurs in either of the processes an auditory alert signal AAS is transmitted through the respective speaker S1-S6. Each event is associated with a specific priority signal PS1-PS3 and an association signal AS.

In FIG. 3 event one, E1 is an event occurring in the cleaning process CP identifying for example a small leak from a pipe which has a mediate priority P2. The auditory alert signal AAS is assembled by a priority sound PS2 comprising two sub sounds and an association signal AS1 based on a sound of a dripping water tap. When the event occur, the alert signal AAS is transmitted to the speaker S1 which is closest to the operator in charge of this specific fault. The same happens when the other events occurs. Where event E2 for example is a larger leak occurring in another part of the cleaning process SP, for example in another line. Since the leakage is larger, the priority is higher P1. Thus the alert signal AAS for the event E2 is assembled by a priority sound PS1 comprising three sub sounds and an association signal AS2 based on a sound of a flowing water tap. The other association sounds, representing the other events E3-E5, may for example be the sound associating to an axe cut AS3, of a branch breaking AS4 or of water boiling in a kettle AS5 and the events they represent may be a fault during feeding of the wood chips E3, a fault during the transportation of the wood chip E4 or a fault during the feeding of bleaching agent E5. Of course are the above described events and association signals only an example of possible events and sounds.

It may also be possible to measure the level and the frequency characteristics of the background sound in the control room or the lunch room and to adapt the auditory alert signal AAS based on the character of the background sound.

1. A method of generating an auditory alert signal (AAS) representing an event (E1-Eₙ) comprising the steps of:
Receiving an input signal (IS1-ISₙ) indicative of the event (E1-Eₙ),
Determining a priority, location and type of the event based on information received from the input signal (I51-ISₙ),
Generating a priority signal (PS) forming a first part of the auditory alert signal (AAS), indicating the priority of the event,
Generating an association signal (AS) forming a second part of the auditory alert signal (AAS), indicating the location of the event (E1-Eₙ) and/or the type of event (E1-Eₙ),
Transmitting the auditory alert signal (AAS) comprising the priority signal (PS) and the association signal (AS) through at least one sound output (S1-Sₙ).

2. The method according to claim 1, wherein the step of transmitting the auditory alert signal (AAS) comprises first transmitting the priority sound (PS) and then transmitting the association sound (AS) sequentially as different separate signals.

3. The method according to claim 1, wherein the method further comprises the steps of receiving the priority signal (PS) and the association signal (AS) from a sound library (L) comprising standardized non-phonetic sounds and/or sub-sounds.

4. The method according to claim 1, wherein the association signal (AS) is based on a non-phonetic sound symbolizing the location of the event (E1-Eₙ) and/or the type of event (E1-Eₙ).

5. The method according to claim 4, wherein the association signal (AS) is based on sound recordings or synthesized sounds or a combination of sound recordings and synthesized sounds.

6. The method according to claim 1, wherein the association signal (AS) gives an immediate and intuitive indication of the type and/or location of the event (E1-Eₙ) without the usage of words.

7. The method according to claim 1, wherein the priority signal (PS) is a non-phonetic standard sound or sub-sound and/or an assembly of non-phonetic sub-sounds received from a sound library (L).

8. The method according to claim 1, wherein priority signal (PS) is generated by assembly of more than one non-phonetic sub-sound received from a sound library (L) and/or generated by creating a signal comprising non-phonetic sounds or sub-sounds with different volume, length, pitch or frequency distribution from said sound library (L).

9. The method according to claim 8, wherein the step of generating a priority signal (PS) comprises assembling a different number of sub-sounds with a different time interval between the sub-sounds.

10. The method according to claim 1, wherein a priority signal (PS) indicating a higher priority comprises a larger number of sub-sounds and/or extends over a longer period of time than a priority signal (PS) indicating a lower priority.

11. The method according to claim 1, wherein the method further comprises the step of generating a priority family comprising an assembly of priority signals (PS) indicating different priorities.

12. The method according to claim 11, wherein the priority family comprises a number of priority signals (PS) comprising a different number of sounds or sub-sounds having a same timbre but different pitch.

13. The method according to claim 1, wherein the auditory alert signal (AAS) is transmitted through the at least one sound output (S1-Sₙ) over a time between 0.5 and 10 seconds, preferably between 0.5 and 5 seconds, more preferably between 1 and 3 seconds.

14. The method according to claim 1, wherein the method further comprises the steps of
measuring the auditory character of the background noise, and
adapting the auditory character of the auditory alert signal (AAS) to the background noise making the signal more audible.

15. The method according to claim 1, wherein the method further comprises the steps of
selecting a specific sound output based on the determined priority, location and type of event (E1-Eₙ),
transmitting the auditory alert signal through the selected specific sound output (S1-Sₙ).

16. An arrangement for generating an auditory alert signal (AAS) representing an event (E1-Eₙ), comprising
a means (M1, M1r) for receiving an input signal (IS1-ISₙ) indicative of the event,
a means (M2d) for determining a priority, location and type of the event (E1-Eₙ) based on information received from the input signal (IS1-ISₙ),
a means (M2p) for generating a priority signal (PS) forming a first part of the auditory alert signal (AAS), indicating the priority of the event (E1-Eₙ),
a means (M2a) for generating an association signal (AS) forming a second part of the auditory alert signal (AAS), indicating the location and/or the type of event (E1-Eₙ), and
a means (M3) for transmitting the auditory alert signal (AAS) comprising the priority signal (PS) and the association signal (AS) through at least one sound output (S1-Sₙ).

17. The arrangement according to claim 16, wherein it comprises a sound library (L) comprising standardized non-phonetic sounds and/or sub-sounds from which the priority signal (PS) and the association signal (AS) is generated.

18. The arrangement according to claim 16, wherein the association signal (AS) is a sound recording or synthesized sounds or a combination of sound recordings and synthesized sounds.

19. The arrangement according to claim 16, wherein the priority signal (PS) comprising assembly of more than one non-phonetic sub-sounds received from a sound library (L).

20. A computer program product stored in a non-transitory computer readable medium which when executed on a computer performs the steps according to the method in claim 1.

21. An auditory alert signal (AAS) representing an event (E1-Eₙ) comprising a priority signal (PS) indicating the priority of the event (E1-Eₙ) and an association signal (AS) indicating the location and/or type of the event (E1-Eₙ).

22. The auditory alert signal (AAS) according to claim 21, wherein the priority signal (PS) and association signal (AS) are non-phonetic and comprise different sound or sub-sounds.
